(19) United States
(12) Patent Application Publication
(10) Pub. No.: US 2002/0070852 A1
(43) Pub. Date: Jun. 13, 2002

(54) Automobile display control system

(75) Inventors: Kenneth B. Trauner, Sacramento, CA (US); Paul J. Weber, Ft. Lauderdale, FL (US); Luiz B. Da Silva, Danville, CA (US)

Correspondence Address: John P. Wooldridge, 1334 Ridgestone Court, Livermore, CA, 94550, US

(73) Assignee: Pearl I, LLC

(21) Appl. No.: 09/735,825

(22) Filed: Dec. 12, 2000

(51) Int. Cl. G06F 3/00

(52) U.S. Cl. 340/438; 340/425.5; 340/540

(57) ABSTRACT

A system is described that improves highway safety by preventing drivers from viewing a display or entering data while the vehicle is in motion. The system monitors the state of the vehicle and enables or disables the different system components that may include microphones, speakers, display screens and input devices such as keyboards, a mouse or a touchscreen. The system allows the vehicle to communicate with cell phones, Internet providers, Bluetooth enabled devices, and other vehicles. The system allows the driver to request information or data when the vehicle is stopped that can be downloaded and stored for later viewing when the vehicle is moving.

### BACKGROUND OF THE INVENTION

1. Field of the Invention

The present invention relates to a vehicular information and display system whose function is dependent on the state of the vehicle. In particular this system monitors whether the vehicle is in motion or stopped and activates the display only when the vehicle is stopped or moving at a velocity below a minimum that can be imposed by law. The system can include a computer and input device so that the user can download information from the internet or other sources. The system also includes a large memory buffer to collect and store requested information which is downloaded during vehicle motion when the display is inhibited. This system improves vehicular safety by preventing the driver from watching a display while driving.

2. Description of Related Art

The information age has made available a wide array of communication tools such as cell phones and Personal Digital Assistants (PDAs) that enable users to quickly and easily transfer large volumes of data. For example Internet enabled cell phones and PDAs now allow wireless access to the internet/web. These devices are now used in vehicles to download driving directions, weather information, e-mails, voice mails, and general data. Cell phone, PDAs and information systems are now being integrated into luxury automobiles. Serious safety hazards are created when drivers use these devices while the vehicle is in motion a.

U.S. Pat. No. 5,541,572 titled “Vehicle On Board Television System” describes a motion sensing system that inhibits a television during motion, but it lacks an integrated data management system that would allow the driver to request information while stopped and have the information downloaded while driving.

There is a need for a vehicular system that prevents drivers from watching or interacting with communication and display devices when the vehicle is in motion. The present invention fulfills this need, and further provides related advantages.

### SUMMARY OF THE INVENTION

An object of the present invention is to provide a vehicular system that allows a driver to safely request and read information or data in the vehicle. An embodiment of the system incorporates a vehicle velocity or state sensor, an input device (e.g., keyboard, mouse, touch screen, and voice recognition software), a display device, a wireless communication device, and a large memory buffer to store data. In normal use, the driver when stopped would have complete access to the system and the information that would be downloaded. However, when the vehicle is in motion the keyboard input and display are inhibited preventing the driver from being distracted while driving.

These and other objects will be apparent to those skilled in the art based on the teachings herein. Other objects and advantages of the present invention will become apparent from the following description and accompanying drawings.

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1 is a block diagram of the key components of the system.

FIG. 2 is a block diagram showing the operation of the system.

### DETAILED DESCRIPTION OF THE INVENTION

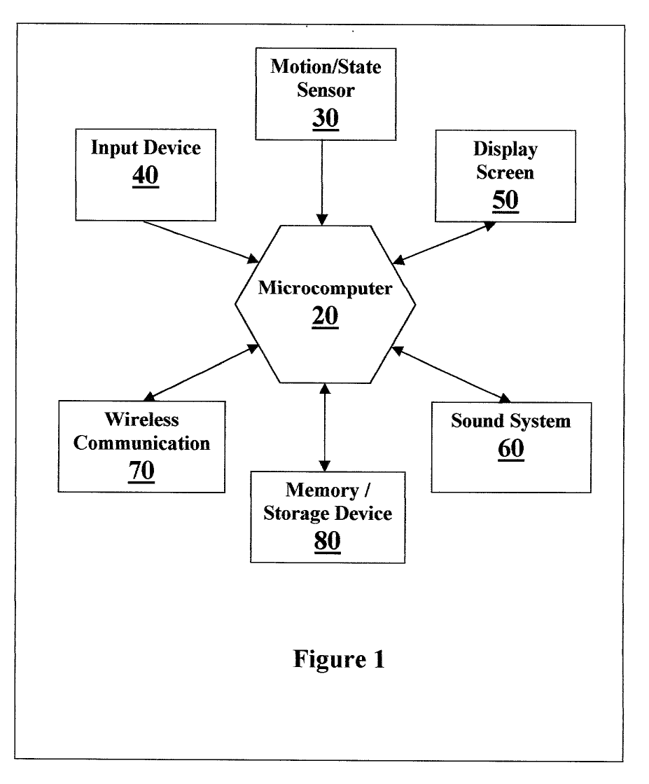

FIG. 1 is block diagram showing the key components of an embodiment of the system. The system 10 includes a microcomputer 20 that controls system operation, a vehicle state/motion sensor 30, an input device 40, a display screen 50, a sound system 60, a wireless communication device 70, and a memory buffer (or alternative storage media, e.g., hard disk, writeable CD) 80. In a preferred embodiment, only the display and input devices are visible and accessible to the driver.

The microcomputer 20 includes a microprocessor, memory, and electronics to condition inputs, drive the display, wireless communication device, and memory/storage devices.

The input device 40 can be any combination of a microphone, a keyboard, a touchscreen, a trackpad, a mouse or other graphic input device. The input device 40 may nongraphic input devices such as sound, motion and/or camera sensors that sense eye motion, nodding or nonverbal cues of a given passenger or driver. The system 10 can include one or a plurality of input devices. These input devices 40 are used to control the system and to generate voice or data to transmit through wireless communication to an external receiver.

The display screen 50 can be any type of display including LCD, active matrix, organic light emitting diode, electronic ink, and plasma. The display may also incorporate a touchscreen. The sound system 60 can use the radio vehicle speakers or have separate dedicated speakers.

The wireless communication device 70 uses standard cell phone circuitry to allow the system to communicate with cell phones and wireless Internet providers. This technology is now available for PDA's and can be easily integrated into the system. The Nextel variant of radio-to-radio cell phone technology may be used to move internet information. Bluetooth wireless technology could also be integrated into the communication device 70, to allow the system to exchange data with portable Bluetooth enabled electronic devices such as personal computers, PDA's and cell phones. Bluetooth refers to a short-range radio technology aimed at simplifying communications among Net devices and between devices and the Internet. It also aims to simplify data synchronization between Net devices and other computers. Products with Bluetooth technology must be qualified and pass interoperability testing by the Bluetooth Special Interest Group prior to release. The Bluetooth 1.0 specification consists of two documents: the Foundation Core, which provides design specifications, and the Foundation Profile, which provides interoperability guidelines. Bluetooth's founding members include Ericsson, IBM, Intel, Nokia and Toshiba.

The state/motion sensor 30 can be simply a direct electrical connection to the vehicle speedometer, which provides a signal that is proportional to the speed. In this case the microprocessor compares the vehicle speed to the maximum allowable speed and if the speed is lower, then the display and input devices are enabled. In one embodiment, voice input and sound through speakers have a different maximum allowable speed than do the display screen or hand activated input devices (keyboard, mouse etc.). This would allow regular cell phone communication to occur while the vehicle was moving at normal speeds. The driver can request from the system multiple sets of data that are downloaded and displayed only when the display is enabled. However, the driver could request this information through voice recognition when the vehicle is moving. For example, the driver could request his/her email, voice mail, daily calendar, weather information, etc., to be downloaded while driving. Voice synthesizing software and speakers can allow the onboard CPU to “read aloud” the screen-blank-hidden but in memory data requested by the driver or given passenger. Many types of speech recognition software are known in the art and usable in the present invention. An available commercial voice recognition package from Dragon Systems, known as “Naturally Speaking,” is a voice recognition software that will translate to digital text spoken words of a user at the normal speeds of human communication in conversation when operating on conventional modem personal computer. Other examples of speech recognition software are provided in U.S. Pat. No. 6,157,906, titled “Method For Detecting Speech In A Vocoded Signal” incorporated herein by reference.

If the display is disabled, the microprocessor 20 controls the download of all this information and stores the requested data into memory 80 (or alternative storage media, e.g., hard disk, writeable CD) for later viewing. This ability allows the driver to request information before starting to drive, or while driving and review it when he stops. The advantage of this is that, with slow data transfer rates, large documents can be transferred while driving and then quickly reviewed or saved.

In one embodiment, the state/motion sensor 30 can include a monitor of the transmission state. In this case the microcomputer could monitor whether the car was in neutral or park and use this to change the state of the system. Additional conditions that could be monitored by the state/motion sensor 30 include whether the driver has a foot on the break, and whether the parking brake is on. Any of these conditions could be used by the microcomputer to control system operation in a way to maximize safety or satisfy local laws or regulations.

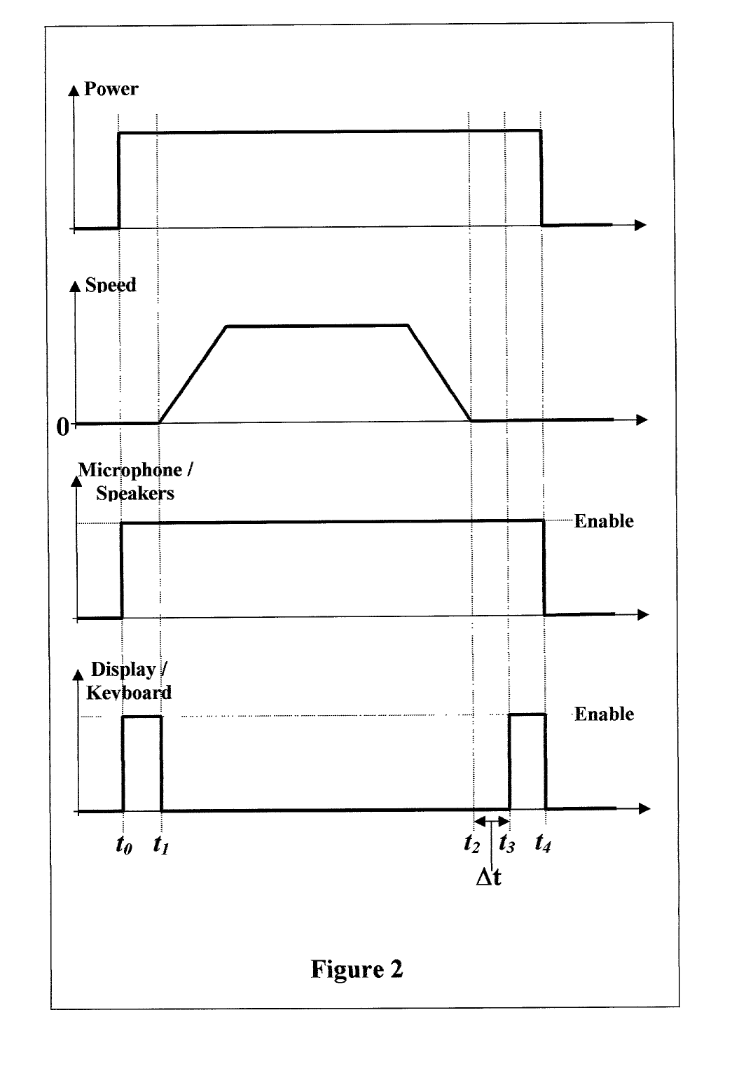

FIG. 2 shows a timing diagram describing how the different states of the system may operate. In the figure, “Power” represents the state when the system is powered on. This state can change when the driver powers up the car, or simply turns the ignition to the accessory power “on” position, or activates a separate system power on switch. The “Speed” timing diagram shows how the vehicle velocity might change in a normal trip. The “Microphone/Speakers” timing diagram represents the state of the voice and sound components of the system. The “Display/Keyboard” diagram represents the state of the display and hand activated input devices. At time t₀, the driver powers up the system and the vehicle is stopped and the speed is 0. In this case the “Voice/Sound” and “Display/Keyboard” are both enabled and the driver can operate the entire system. At a time t₁, the driver starts to move and the “Display/Keyboard” state changes to disabled, thereby preventing the driver from looking at the display and using any of the hand activated input devices. At a time t₂, the driver has decelerated and is once again stopped. At a time t₃, which occurs after a predefined minimum time interval Δt, or when the driver changes the driving state (e.g., when the driver puts the transmission into park, or neutral with a foot on the break, or just in any gear or idle, but not moving or exceeding a predetermined speed e.g., 2 mph), the “Display/Keyboard” state changes to enabled, once again allowing the driver to view the display and use the hand activated input devices. At a time t₄, the driver turns the system off by either powering the vehicle off by turning the ignition key to the off position, or deactivating a separate system power switch.

While moving, the present system can be put into a mode to slowly read the downloaded information via computer voice synthesis. Voice confirmation may be provided that searches have been completed (while the vehicle is in motion). Voice prioritization may be used to prioritize searches. In the opposing direction, voice recognition software can take verbal command from a given occupant of the vehicle and send a command back through the internet A scroll function of completed searches is operated with a bi-directional control button(s) mounted on the steering wheel, computer or other convenient location to allow the driver to quickly search through downloaded information when the vehicle is at rest. A headpiece/earpiece attachment may be provided for clear voice interaction with the computer and for privacy. The system allows for preprogrammed functions to easily request functions while in transit. For example, “GPS map” plots the current car position, “traffic monitor” generates a traffic search for the current GPS position and “check e-mail account x” checks account x e-mail. A user may verbalize a series of functions for the computer to perform while the vehicle is in motion, and the user can view these function when the vehicle comes to a stop.

The system may be guided by the vehicle motion and by infrared, radar or microwave sensors placed in vehicle that provide information as to whether traffic or any other thing about the car that may demand the driver's attention. Colored indicator lights inform a user of the system status, search status, etc.

The above descriptions and illustrations are only by way of example and are not to be taken as limiting the invention in any manner. One skilled in the art can substitute known equivalents for the structures and means described. The full scope and definition of the invention, therefore, is set forth in the following claims.

We claim:

1. An apparatus, comprising:
a vehicle velocity sensor for operative connection to a vehicle to sense the velocity of said vehicle;
at least one peripheral device selected from the group consisting of an input device, a display device and a wireless communication device; and
a computer operatively connected to said vehicle velocity sensor and said at least one peripheral device, wherein said computer comprises memory and software, wherein said software monitors said vehicle velocity sensor and disables a selected peripheral device when said vehicle is moving at least as fast as a selected velocity, wherein said software is operable while said vehicle is moving.

2. The apparatus of claim 1, wherein said input device is selected from the group consisting of a keyboard, a mouse, a trackpad and a touch screen.

3. The apparatus of claim 1, wherein said input device comprises sound, motion and/or camera sensors that sense eye motion, nodding or nonverbal cues.

4. The apparatus of claim 1, wherein said input device comprises a keyboard, wherein said software disables said keyboard and said display when said vehicle is in motion.

5. The apparatus of claim 1, wherein said at least one peripheral device further comprises a sound system.

6. The apparatus of claim 1, wherein said memory comprises a medium selected from the group consisting of a hard disk and a writeable CD.

7. The apparatus of claim 1, wherein said display comprises a screen selected from the group consisting of an LCD, an active matrix, an organic light emitting diode, electronic ink and a plasma display.

8. The apparatus of claim 1, wherein said wireless communication device comprises Bluetooth technology.

9. The apparatus of claim 1, wherein said vehicle velocity sensor is directly connected to the vehicle speedometer, which provides a signal that is proportional to the speed.

10. The apparatus of claim 9, wherein said software compares the vehicle speed to a maximum allowable speed and if the vehicle speed is lower that said maximum allowable speed, then said input device and said display device are enabled.

11. The apparatus of claim 10, wherein said software comprises a different maximum allowable speed for voice input and sound through speakers than for display and hand activated input devices to allow regular cell phone communication to occur while the vehicle was moving at normal speeds.

12. The apparatus of claim 11, where a driver can request from the system multiple sets of data that are downloaded at any desired time but are displayed only when said display is enabled.

13. The apparatus of claim 12, wherein said software comprises means for voice recognition.

14. The apparatus of claim 5, wherein said software comprises voice synthesizing software to read aloud requested data available in said memory even when said display is disabled.

15. The apparatus of claim 1, further comprising a vehicle state sensor for operative connection to a vehicle component to sense the condition of said component.

16. The apparatus of claim 16, wherein said vehicle component is selected from a group consisting of a vehicle transmission and a brake.
